(19) United States
(12) Patent Application Publication
(10) Pub. No.: US 2007/0207310 A1
(43) Pub. Date: Sep. 6, 2007

(54) Chrome coated surfaces and deposition methods therefor

(76) Inventor: Daniel M. Storey, Longmont, CO (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/593,701

(22) Filed: Nov. 6, 2006

Related U.S. Application Data
(60) Provisional application No. 60/779,122, filed on Mar. 3, 2006.

(51) Int. Cl. G11B 5/64; B32B 17/10; B05D 1/36; C08F 2/46; H05H 1/24

(52) U.S. Cl. 428/336; 428/409; 428/457; 428/337; 427/569; 427/402; 427/487

(57) ABSTRACT

A plasma vapor deposition method for producing highly reflective and adherent metal or metal alloy decorative coatings on articles such as automotive fixtures is described. The improved coatings are particularly applicable to chrome based coatings on automobile fixtures and accessories, including wheels, hubcaps, bumpers and door handles. The method also provides plated metal coatings such as gold, platinum and silver for jewelry and industrial tools.

This application claims benefit of U.S. Provisional Application Ser. No. 60/779,122 filed Mar. 3, 2006, which is incorporated by reference in its entirety.

### BACKGROUND OF THE INVENTION

1. Field of the Invention

The invention relates to ionic plasma deposition methods for preparing highly reflective coatings substrate surfaces and more particularly to highly adherent chrome coatings on metal and plastic surfaces.

2. Description of Background Art

Currently employed methods for chrome plating are generally limited to electrodeposition and vacuum metallization. While chrome and chrome-based metals are highly desirable as a decorative finish, particularly for automotive vehicles, the coatings are expensive to produce and are subject to delamination and poor adhesion.

Chrome plating is typically applied to metal substrates such as wheels and hubcaps using electroplating methods. The process requires first cleaning the wheels in order to provide a homogeneous surface for an adherent coating. This is basically a stripping process used to produce a clean surface and generally employs dipping or exposing a substrate metal surface to one or more strong acids, such as sulfuric acid. The surface cleaning step is followed by a polishing step to ensure a smooth, blemish-free surface for the chrome plating to meet the quality standards required for consumer sales. The prepared surface is coated with several metal layers, and may employ as many as three different metals to triple plate the surface. In the plating industry, the metals typically include copper, nickel and a top layer of chrome. Multiple underlayers are often used in the manufacture of high quality chrome; for example, as many as five layers may be present, starting with nickel, copper, a second copper layer, a second nickel coat and a top chrome coat. Some of the coats may be applied electrochemically; others by a dipping process. Each step requires the part to be submersed in chemical solutions, which can be highly basic or acidic, depending on the metal used for the coating and the type of application process employed.

The final step in the chroming process is an electrochemical deposition of chrome. The part to be coated is dipped into a chrome bath, which is a solution of either hexavalent chrome or trivalent chrome. The part is plated by electrochemically depositing a thin film of chrome, which after cleaning and polishing provides a durable and shiny surface.

Despite multiple steps to assure high quality and an adherent coating, the failure rate using the electroplating process is generally high, mainly because a high quality product is expensive and labor intensive to produce. The coatings are susceptible to rapid rust and corrosion if the plated surface is damaged, causing the plating to delaminate from the surface.

Electroplating is widely used for decorative, wear and corrosion protection. The electroplating process has two major drawbacks: the need for polishing and the large amount of waste produced from the process. Polishing of the surface before electroplating is necessary so that a smooth surface is introduced into the electroplating bath in order to assure a defect-free coating; however, the multiple steps and quality controls are time consuming and labor-intensive, requiring a high level of knowledge and skill to perform the actual polishing.

The hazardous waste produced by electroplating processing methods presents significant environmental and economic issues. The electroplating industry is a relatively large industry with hundreds of job shop and captive operations in the United States. Toxic chemicals such as chromic acid and cyanide are typically used in the plating and for metal surfaces at least, strong acids may be used to clean surfaces. Multiple cleaning and plating steps result in the generation of large quantities of hazardous solid and liquid waste. For the past two decades, considerable effort has been made to minimize this waste, yet effective, economical solutions have not been found. This waste material generates thousands of gallon/day of effluents, resulting in solid waste treatment costs that may exceed at $1000/day, and result in more than 15 ton/week sludge which additionally add to disposal costs.

Sputter deposition of metals, including chrome, has also been used for making decorative coatings. This normally requires depositing a coating on top of an organic polymer. The technique uses ions accelerated toward a target of metallic material. When the ions hit the target, individual metal atoms are “knocked off.” While this method overcomes the waste issues associated with electrochemical deposition methods, it tends to result in poor adhesion of the sputtered ions on metal substrates. The process is not amenable to scale-up, making cost effectiveness a major consideration.

Sputtering is a low energy process compared with ion plasma deposition because incoming sputtered ions do not have sufficient energy to securely implant into the substrate surface. In attempts to improve adhesion, metal substrates are usually coated with a so-called “seed layer.” Even with seed layers, adhesion is moderate at best. This is generally satisfactory for flat surfaces but if the substrate is twisted, bent or otherwise deformed, as is typically the case for automobile parts, the coatings are likely to delaminate, leading to corrosion and part failure.

Sputter coating is not an attractive process for large scale production because it is difficult to scale-up and therefore may not be economically feasible. This is due in part to the complex fixturing, small throwing power and limitations on target size because parts need to be close to the target. The area that can be treated at any one time is typically limited to 20-100 square inches. It is thus not only economically inhibiting to scale up the sputtering process, it is virtually impossible.

Efforts have been made to develop other processes which do not require use of hazardous solvents. Vacuum metallization, for example, eliminates the use of hazardous solutions and is performed in four stages: initial cleaning or preparation of the target surface utilizing a number of steps, a base coat application stage; a two-step physical vapor deposition (PVD) stage, and a top coat application stage.

U.S. Pat. No. 6,346,327, for example, describes ultrasonically cleaning and drying a steel substrate before applying a heat curable polymer coating which is baked onto the substrate surface to form a basecoat film. In subsequent steps a coating of chrome, chrome-nickel alloy or chromium nitride is applied on top of the basecoat, described as employing electroplating or vapor deposition. Unfortunately, the polymeric materials used for the base coat require or generate heat during polymerization, which may affect the substrate surface, particularly where plastic substrates are employed because melting or significant deformation of the coated article may occur.

A method for producing chrome-based coatings on polymers is described in U.S. Pat. No. 6,861,105 where a polymer substrate is coated with one or more conductive layers before applying a chrome coating using a vapor deposition method. While this method is asserted to provide a scratch resistant coating on plastic, a conductive layer must first be applied to the substrate, thereby increasing processing steps and manufacturing costs.

A polymeric base coating for an article such as a faucet is described in U.S. Pub. No. 2004/0038068 where one or more coatings are applied over a polymer coat which is cured at sub-atmospheric (reduced) pressure. An exemplary polymer is heated to a relatively high temperature, 560° F., in order to effect curing, after which stack layers of metal compounds are deposited by physical vapor deposition.

U.S. Pat. No. 6,702,931 describes a metal alloy oxide coating method employing a basic vacuum arc deposition procedure. The target is a single phase alloy material said to reduce occurrence of droplets during reactive vacuum arc evaporation. Deposition of a metallic intermediate layer is suggested as useful for increasing adhesion of a deposited aluminum/chromium layer.

Deficiencies in the Art

Despite progress in manufacturing techniques and more efficient deposition steps, there remains a need for improved chrome plated surfaces that are resistant to harsh environmental conditions and delamination and that do not require manufacturing processes that use toxic or dangerous chemicals.

### SUMMARY OF THE INVENTION

The present invention addresses some of the major deficiencies in metal plating processes, and particularly addresses the problems encountered in providing high quality chrome or chrome-alloy coatings. The disclosed method is economical and is an acceptable replacement for environmentally unfriendly liquid coating processes such as electroplating and electro-less plating, and is also an improved alternative to more expensive and time-consuming metal deposition methods.

The coatings provided by the described method are not limited to flat surfaces and can be used on any shape substrate, including irregular curved surfaces of metals, plastics or ceramics. The method is particularly useful in metal plating because the metal films produced are highly adherent, resist delamination and can be deposited as thin films that retain desired appearance and performance characteristics.

The method is also applicable for coating articles such as jewelry with thin adherent layers of rare or expensive metal coatings, including gold, platinum and iridium and alloys or combinations of these metals with other suitable metals. A particular advantage is the resultant high quality coatings using relatively small amounts of precious or rare metals.

The inventive method is a process that provides three or four-layer coatings over a selected substrate surface. The coatings comprise a unique combination of a first electrodeposited polymer base coating on the substrate surface followed by an ultraviolet-curable polymer coating. The top layer is an ion plasma deposited metal layer, preferably comprising chrome or chrome alloys, which is optionally covered with a polymer top coating as a fourth layer.

The first polymer base coat is deposited on the substrate as a relatively thin layer, and is preferably an electrodeposited polymer about 1 to about 10 microns thick. The base coat may be selected from a wide range of polymers with electrodeposited or UV curable polymers being preferable; for example, the CorMax® line of electrocoat products (DuPont) provides several suitable polymers for electrodeposition.

A base coat need not necessarily be applied by electrodeposition but may be applied by dipping or flooding so long as the coating can be cured or hardened without an undue amount of heat. Powder organic coatings applied by ionic spray are not generally appropriate because currently used powder coatings require use of high heat for relative long periods of time (e.g., 45 min) and high curing temperatures may cause damage or deformation of the substrate. The selected base coat polymer need not be clear but should be selected for optimal adherence to the selected substrate.

The second layer is a polymer that should fulfill two purposes: providing a smooth surface for subsequent metal deposition, thereby eliminating the need for polishing; and not requiring high temperatures to form an adherent polymer coating on the deposited base polymer coat. This is best achieved by using ultraviolet curable polymers. The low temperature processing is a distinct advantage when non-metal or heat deformable substrates are used, making it possible to apply metal coatings to heat-sensitive plastics which can be significantly deformed during the heating used during other polymerization processes that require elevated temperatures for curing.

The third layer over the two polymer layers is a vapor deposited metal coating, which is applied using a plasma deposition process, most preferably the modified ionic plasma deposition (IPD) process set forth herein. A highly preferred metal coating is chrome, although other metals, particularly those desired for decorative surfaces, may be used, including the noble metals, gold, platinum, palladium, iridium, ruthenium and silver. Additional metals of interest include molybdenum, tantalum, tungsten, copper, tin, alloys of these metals and other metals amenable to ionic plasma deposition (IPD). Alloys may include nickel-iron, nickel-cobalt, nickel-tin and cobalt-tin. Select metals are desirable as coatings on jewelry, automotive parts, or as decoration or protective coatings on a variety of metal or plastic articles. Platings or coatings prepared from transparent ruthenium combined with gold or other precious metals may be desirable in other applications such as decorative objects or jewelry.

Optionally, a metal-coated substrate may be top-coated with single or multiple additional polymer layers. Such additional layers are preferably polymerized by ultraviolet light, or other means that do not generate significant heat, particularly when there is a potential for the substrate to be affected by the high temperature required for polymerization of many types of polymers.

The new metallizing process of the present invention generally includes three stages: a cleaning or preparation stage, a base coat application stage including at least two separately applied polymers, and an ion plasma deposition (IPD) process for applying the metal coating on the substrate. A fourth stage is an optional coating that serves as a protective or color enhancing top coat over the IPD deposited metal. Each stage utilizes defined process steps and selected formulations that will vary for optimization with different metal or plastic substrates.

A wide range of materials may be used as substrates for the disclosed coating process, including glass, ceramic, plastics and metals. In particular, zinc, aluminum, steel, bronze, a variety of alloys and plastics such as ABS and ABS/PC may be used. In the automobile industry, preferred substrates for chrome coatings include not only metals such as aluminum and steel, which are typically used on motorcycle framesets and bolts and on automobile wheels, hubcaps, bumpers, and the like, but also different plastics which are used as substrates for a variety of insignias, handles, holders, wheel covers and similar parts.

In a first coating step of the disclosed process, an organic polymer base coat is coated in a layer that is several microns thick. Electrodeposited coatings are preferable and suitable polymers for electrodeposition include polyimide, polypyrrol, polyurethane, polyaniline, poly (N-ethyl aniline), poly (O-anisidine), ethyl acrylate methyl methacrylate methacrylic acid terpolymer, and the like. Polyurethane, for example, may be electrodeposited as a first layer and cured by exposure to ultraviolet light. DuPont's CorMax® electrocoat products are particularly suitable and highly preferred, including CorMax® III, CorMax® Vi, CorMax® VI EP, CorMax® VI HAPS free, CorMax® for frames, CorMax® VI low bake, CorMax® VI Kai and CorMax® pre-blend with Teflon®.

In some cases, a base coat of an UV curable polymer may act as the base coat without an underlying electrodeposited coat. The metal top coat, or metal coat with an additional polymer coat, meets standards for adhesion, hardness and thermal cycling but may not provide a sufficiently smooth base coat surface for rough substrates to provide highly polished mirror smooth decorative surfaces.

A second polymer coating is over the base polymer coating is preferable; however, the second coating can be a second thin coating of an initially applied UV curable polymer. In any event, the UV curable polymer may be selected from a wide variety. Many such polymers are known and can be selected on the basis of any of a number of factors, including cost, range of UV radiation required for curing, curing rate, etc. Typical classes of UV curable polymers include epoxyacrylates, polyester oligomers, polyacrylamides, polyacrylates, polymethacrylates, epoxysilicones and epoxyesters. Particular polymers are polyethylene glycol diacrylate polyvinylidene fluoride blend gels, urethane acrylate, polyacrylamide polyvinyl alcohol, unsaturated polyester resins, hyperbranched polyesters, star branched polyesters and numerous blends such as epoxy functional diorganopolysiloxanes. Polymers with curing temperatures at or below room temperature are particularly preferred, particularly when thermally deformable plastic substrates are used. Production costs are also saved when heating is not required.

One or more metal coatings, preferably chrome, may be applied on top of the first or second base polymer layer using a vapor deposition procedure, preferably the modified vacuum arc ion plasma deposition (IPD) process described herein. Typical metal or metal alloy coatings are between 10 and 3000 nm, preferably between 100 and 2000 nm, and most preferably between 500 and 1500 nm in thickness for each metal, if more than one metal or more than one metallic layer is applied. Chrome is a highly preferred metal coating and can be deposited by IPD from targets such as chromium bitride, chromium carbide, chromium oxynitride, chromium oxycarbide, chromium carbide nitride or chromium nickel.

An additional top layer coating may optionally be applied over the metal layer. This may be desirable for enhanced protection from scratches or for appearance. For example, modifications to a bright-chrome appearance have recently become popular. So-called “dark” or “black” chrome coatings are in demand for use on automotive parts and other decorative fixtures. The coatings of the present invention may optionally include lacquer-type top coats containing dyes that provide a dark or translucent color, for example applied as an anophoretic lacquer, then dyed and cured. Cured coatings 15-18 microns thick are typically used over gold and nickel substrates. Catophoretic lacquering processes have been used in the art for coating on zinc and silver.

The invention provides a highly adherent surface coating on a substrate. The base coat is preferably an electrodeposited polymer which is then coated with an ultraviolet curable polymer coat. The third coat, which can be the top coat, is an IPD deposited metal that can optionally be coated with an additional polymer overlayer. Whether three or four layers, the deposited metal surface meets or exceeds AST B-117, ASTM D-3359, ASTM D-3363 and GM 264M standards relating to salt resistance, adhesion, hardness and thermal cycle standards in the automobile industry.

The substrate may be metal, ceramic or polymer. For automobile parts, for example, the substrate is generally steel or aluminum, although decorative parts such as logos are often made of different types of plastic. Steel and aluminum are particularly preferred as the substrate for wheels, hubcaps and bumpers.

Plastic substrates may be selected from a large number of different types of plastic; a few common examples include PEEK, PTFE, EPTFE, UHMWPE and ABS.

The electrodeposited substrate surface base coats are preferably selected from specially designed polymers such as the DuPont CorMax® line of electrocoating products, namely, CorMax® III, CorMax® Vi, CorMax® VI EP, CorMax® VI HAPS free, CorMax® for frames, CorMax® VI low bake, CorMax® VI Kai and CorMax® pre-blend with Teflon®. CorMax® III is particularly preferred.

An electrodeposited surface coating is second-coated with a UV curable polymer. Typical types of UV curable polymers include epoxyacrylates, polyester oligomers, polyacrylamides, polyacrylates, polymethacrylates, epoxysilicones and epoxyesters. Examples include polyethylene glycol diacrylate polyvinylidene fluoride blend gels, urethane acrylate, polyacrylamide polyvinyl alcohol, unsaturated polyester resins, hyperbranched polyesters, star branched polyesters and epoxy functional diorganopolysiloxanes.

The metal coating applied on top of the UV cured polymer is highly adherent in addition to meeting the aforementioned hardness, salt resistance, and thermal cycling tests. These characteristics are of high importance in the manufacture of trim and decorative fixtures, particularly where chrome is coated on a metal or plastic substrate. In this respect, it has been found that particularly preferred IPD deposited metal coatings for automobile parts and related fixtures are chromium nitride, chromium carbide, chromium oxynitride, chromium oxycarbide, chromium carbide nitride or chromium nickel.

It is particularly desirable to coat vehicular parts with chrome. Exemplary parts include wheels, hubcaps, bumpers, door handles, mirror attachments, and decorative appurtenances.

With respect to chrome or chrome-alloy coated materials, surfaces coated with an electrodeposited polymer base coat, an ultraviolet curable polymer coat over the base coat, an IPD chrome or chrome-alloy coat and, optionally, a polymer top coat over the IPD chrome or chrome-alloy are particularly preferred. Total thickness of the metal over the base coats may range from about 5 nm to about 500 nm thick.

The thickness of an electrodeposited polymer base coat, regardless of the metal coating, is generally about 1 to about 10 microns thick. The subsequently deposited ultraviolet curable polymer coat is about 5 to about 15 microns thick.

Preparing a substrate surface for depositing a highly decorative finish such as chrome is important, particularly when the substrate is a metal. The surface should be thoroughly cleaned, and if a smooth surface is desired, polished or scraped to remove roughness. Thereafter, the electrodeposited base and UV curable second coats may be applied followed by an IPD deposition of chrome or a chrome alloy. The texture and appearance of the deposited metal surface may be controlled by adjusting IPD conditions; for example a macro dense particle coating is produced by controlling the IPD at about 100 Hz while a relatively macro-free coating is produced by controlling the IPD at about 300 Hz. When a smooth surface is desired for metal deposition, the IPD process is adjusted to provide a relatively macro-free coating which contains fewer particulates above 100 microns than macro dense coatings.

Using the IPD method of metal deposition, suitable targets for obtaining a chrome-containing layer include chromium nitride, chromium carbide, chromium oxynitride, chromium oxycarbide, chromium carbide nitride or chromium nickel.

As discussed, the electrodeposited polymer base coat may be selected from any number of suitable polymers, with CorMax® III, CorMax® Vi, CorMax® VI EP, CorMax® VI HAPS free, CorMax® for frames, CorMax® VI low bake, CorMax® VI Kai and CorMax® pre-blend with Teflon®, with CorMax® III being particularly preferred.

### DEFINITIONS

Ionic Plasma Deposition (IPD) as used herein refers to the use of a modified controlled vacuum arc discharge on a target material to create highly energized plasma. IPD differs from normal vacuu arc in the precise control of arc speed and providing the option of mixing the size of deposited metal particles. Depositions of large macro particles result in nano-rough surfaces while deposition of a majority of small macro particles provides a more nano-smooth surface.

Macros and macroparticles refer to particles larger than a single ion. Small macro-particles refer to particles from two atoms to approximately 100 nanometers. Medium macro-particles refer to particles from 100 nanometers to about 1 micron. Large macro-particles refer to particles larger than 1 micron.

The term “a” as used herein to define the claims is not necessarily limited to a single species.

“About” as used herein is intended to indication that there may be choice and variation in the numbers stated and that some experimentation may be required to obtain the results described, normally within a reasonable range of value.

AST B-117: standard salt chamber test for corrosion testing. Appearance of corrosion in the form of oxides is evaluated after a selected period of time.

ASTM D3359: standard test for measuring adhesion by a “tape test” where pressure sensitive tape on cuts made in a coating film are removed and observed to note whether or not the coating remained intact.

ASTM D3363: standard method for testing film hardness using a “pencil test” where film hardness on an organic coating on a substrate is evaluated in terms of drawing leads or pencil leads of known hardness.

GM 264M: a general test used by General Motors in determining flaking (adhesion) of chrome on automobile parts.

### BRIEF DESCRIPTION OF THE FIGURES

FIG. 1 shows a typical IPD apparatus used to deposit metal coatings such as chrome: target material 1; substrate 2; movable holder for the substrate 3; vacuum chamber 4: power supply for the target 5; and arc speed control 6.

FIG. 2 depicts a typical chrome coating: ultraviolet curable organic polymer top coat approximately 10 microns thick 1; 500 nm thick 99.995% chrome coating approximately 500 nm thick 2; ultraviolet curable organic polymer coat approximately 10 microns thick 3; electrodeposited polymer approximately 10 microns thick 4; and metal or polymer substrate 5.

### DETAILED DESCRIPTION OF THE INVENTION

The present invention discloses a method that produces high quality metal coatings on a wide range of substrates and is particularly suitable for manufacturing decorative coatings such as chrome. The method not only provides superior coatings but also avoids generation of large amounts of toxic waste and is economically attractive for large scale operations. Significant reduction of costs for commercial chrome coating operations is possible using coating steps that are rapid and applicable to metal, plastic and ceramic surface coatings. The coatings produced are highly adherent on plastic or metal surfaces and are resistant to salt, thermal variations and surface damage.

It is difficult and expensive to produce high quality chrome surfaces that meet expectations of adherence, hardness and resistance to atmospheric exposure. Of equal importance for consumer acceptance and marketability, highly reflective, smooth polished surfaces are particularly desirable. The ability to produce brilliant, smooth chrome surfaces is a unique aspect of the present invention. The present invention provides a multicoating process that is applicable to coatings on metal and non-metal substrates, especially on various types of polymer based materials. While ideally, four different coatings are recommended including the deposited metal, improved coatings can be achieved with a single polymer coating over which a metal is deposited by a closely controlled ion plasma deposition (IPD) process. Thus a UV cured polymer base coat can be coated with an IPD deposited metal; however, this is not ideal for coated parts or jewelry subject to contact wear and tear.

For chrome coatings, a smooth substrate surface is required so that subsequently deposited metal will not have a pitted or rough appearance. A polymer base coat over a substrate acts to provide a smooth coated substrate. Electrodeposited polymers are preferred as a “smoothing” coat with the added advantage of high adherence to the underlying substrate. The base coat can be a dipped or flowed polymer that is cured with UV light or low heat, but adherence may be less satisfactory.

When the base coat is an electrodeposited base coat, additional advantage in coating properties is achieved by a second polymer coating, cured over the base coat by UV light. This creates a superior surface for IPD metal deposition. If deposition is on an electrodeposited polymer, adherence may be poor or deposits may be uneven.

The deposition process providing the metal surface coat employs a controlled ionic plasma deposition procedure. Control of the deposition so that the surface is evenly coated with very small particles, basically macro particles less than 1 micron in size, is important in achieving the highly adherent, brilliant surfaces desired in chrome or precious metal plating. The process is based on control of substrate distance and/or arc speed in a vacuum arc ionic deposition. Thus controlling the IPD at about 300 Hz results in a relatively macro-free chrome coating. Control at lower power, about 100 Hz, results in macro-dense deposits (much larger particles), which significantly increases surface roughness and is not conducive to production of highly polished, reflective chrome surfaces. On the other hand, there may be cases where surface roughness is desirable, possibly for a specialized appearance, so that arc control can be used to deposit a relatively nano-rough surface.

Top protective coats on decorative surfaces such as chrome are optional, but can be used where there is exposure to abrasive conditions or elements that add to wear and tear. Generally, such protective coatings will be polymeric, preferably UV curable to avoid heat damage such that may occur at the high temperatures required for many polymers. Any excessive heat may also affect the underlying base polymer coatings as well as the substrate itself. Therefore the optional top coatings should be a UV curable polymer in order to achieve the quality metal coatings provided by the disclosed method.

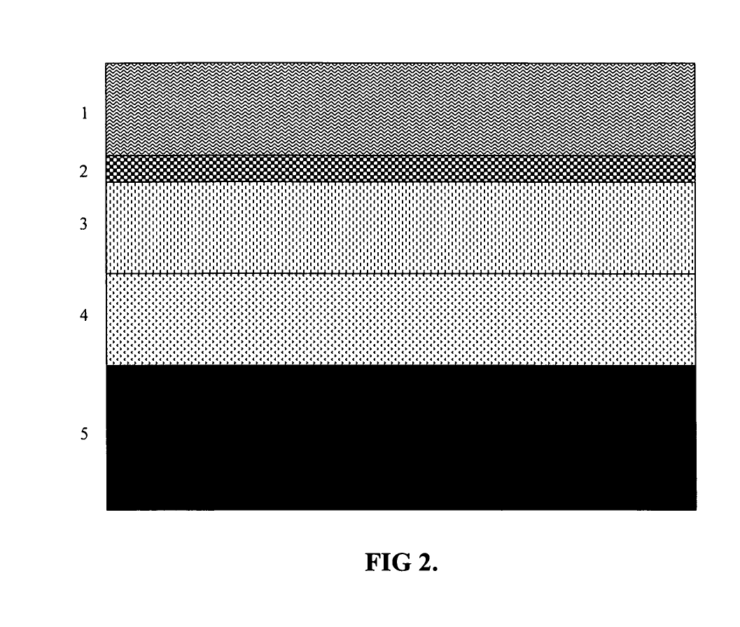

A typical four-coated substrate is illustrated in FIG. 2. The base layer thickness can be about 1 up to about 10 microns for an electrodeposited polymer 4 over the substrate 5; an ultraviolet curable polymer layer of about 5 up to about 15 microns thick 3; a relatively thin IPD deposited metal layer of about 10 up to about 3000 nanometers 2; and an UV curable top coating that can range from 1 to 20 microns preferably 15-18 microns over some substrates such as gold and nickel or ranging form 1 to 5 microns over other deposited metals.

### EXAMPLES

The following examples are provided as illustrations of the invention and are in no way to be considered limiting.

### Example 1

### Ion Plasma Deposition of a Metal

Ionic Plasma Deposition (IPD) utilizes a modified controlled vacuum arc discharge on a target material to create highly energized plasma. IPD differs from normal ion plasma depositions in several ways, including control of substrate distance from the target and precise control of arc speed. Arc control allows for faster movement, creating fewer macro particles without the use of sensors or filters. Slower movement deposits more macro particles leading to a rougher surface. Adjusting substrate distance from the target during deposition also controls density and size of the macro particles deposited.

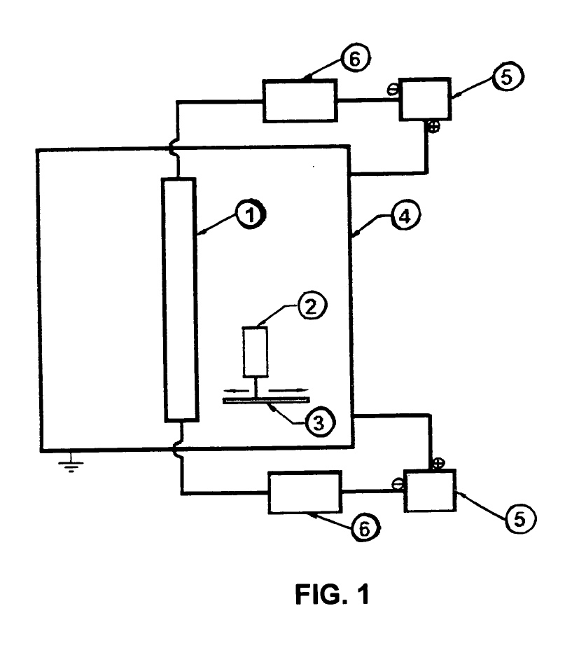

A typical apparatus for using the modified IPD method is shown in FIG. 1. Deposition conditions are adjusted to the size and type of substrate, the target material, which for the examples shown is chrome or a chrome alloy. The substrate, which can be aluminum or steel as illustrated in the examples, is placed at a distance from the target so that a metal/metal oxide film is deposited over the surface as either a macro dense film or a relatively macro-free film. The number and size of macroparticles deposited can also be controlled with arc speed; for example controlling IPD at 100 Hz results in a macro dense metal coating while IPD control at 300 Hz provides a relatively macro free surface which exhibits significantly less nano-roughness than a macro dense surface.

### Example 2

### Chrome Coated ABS Plastic

A solution of an ultraviolet curable polymer was flooded over the surface of an ABS plastic part at a thickness of ten microns and pre-cured for 120 sec. with radiant heat at 100° C. The part was then placed under a UVB light for eight min until fully cured. 99.99% chrome was deposited by the IPD method with IPD control at 300 Hz in accordance with the method of example 1 to a depth of 500 nm. An epoxyacrylate polymer was then coated to a thickness of 2 microns followed by curing for 120 sec. at a temperature of 100° C.

The quality of the coating met or exceeded the following standards: AST B-117 (salt spray); ASTM D-3359 (adhesion by reverse saw cut); ASTM D-3363 (hardness using gravelomener); and GM 264M (thermal cycling −30° C. to +85° C.)

### Example 3

### Chrome Coated Hardened Steel or Aluminum

A hardened steel automotive wheel with major surface roughness was cleaned with phosphate solution followed by electrodeposition of an organic polymer to a thickness of 5 microns. A solution of an ultraviolet curable organic polymer was deposited by flood coat at a thickness of 10 microns and pre-cured for 120 sec with radiant heat at 100° C. The part was then placed under a UVB light for eight minutes until fully cured. A 99.995% chrome coating was deposited by the IPD method of example 1 controlled at 300 Hz to a thickness of 500 microns. A solution of an ultraviolet curable organic polymer coating was deposited by flood coating to a thickness of 2 microns and pre-cured with radiant heat for 120 sec at 100° C. The part was then placed under a UVB light for eight min until fully cured.

The analogous procedure was used to coat an aluminum substrate.

The quality of the coating on either the hardened steel or aluminum met or exceeded the following standards: AST B-117 (salt spray); ASTM D-3359 (adhesion); ASTM D-3363 (hardness); and GM 264M (thermal cycle.)

While the present invention has been described with reference to specific embodiments thereof, it should be understood by those skilled in the art that various changes and modifications may be made and equivalents may be substituted without departing from the true spirit and scope of the invention; in particular, it will be understood that there are several combinations of targets and substrates that may be used and that deposition conditions may be modified within the described scope to achieve optimal results tailored to the specific materials employed.

### REFERENCES

U.S. Pat. No. 6,861,105 Veerasamy, March 2005

U.S. Pat. No. 6,346,327, Mokerji, February 2002

U.S. App. Pub. No. US 2004/0038068

U.S. Pat. No. 6,702,931, Brandle, et al., March 2004

U.S. App. Pub. No. US 2004/0038068

U.S. App. Pub. No. US 2005/106067, Kapourchali and Khalilian

02853670/FR, Bergmann, et al.

U.S. App. Pub. No. 2004/0038068, Finch, et al.

U.S. App. Pub. No. 2003/0209424, Brandle, et al.

U.S. App. Pub. No. 2001/0006091, Eikhoff and Hanczaruk

U.S. Pat. No. 6,200,411, Eikhoff and Hanczaruk

Pat. No. 02731234/FR, Trester

U.S. Pat. No. 4,035,321, Shahidi, et al., Jul. 12, 1977

Xie, J., et al., “Ultraviolet-curable polymers with chemically bonded nanotubes for microelectromechanical system applications” v. 11, August 2002, 575-580.

U.S. Pat. No. 6,855,437, Tolls, et al., Feb. 15, 2005.

What is claimed is:

1. A substrate surface coating comprising:
an electrodeposited polymer base coat;
an ultraviolet (UV) curable polymer coated over the base coat;
an ionic plasma deposited (IPD) metal coat over the UV curable coat; and
optionally, a polymer coating over the metal deposited coat
wherein the substrate surface coating meets or exceeds AST B-117 salt resistant standards, ASTM D-3359 adhesion standards, ASTM D-3363 hardness standards and GM 264M thermal cycle standards.

2. The substrate surface coating of claim 1 wherein the substrate surface comprises a metal, ceramic or plastic.

3. The substrate surface coating of claim 1 wherein the substrate surface comprises steel or aluminum.

4. The steel or aluminum substrate surface of claim 3 which is comprised in a wheel, hubcap or bumper.

5. The substrate surface of claim 2 wherein the plastic is selected from the group consisting of PEEK, PT FE, EPTFE, UHMWPE and ABS.

6. The substrate surface coating of claim 1 wherein the electrodeposited polymer base coat is selected from the group consisting of CorMax® III, CorMax® Vi, CorMax® VI EP, CorMax® VI HAPS free, CorMax® for frames, CorMax® VI low bake, CorMax® VI Kai and CorMax® pre-blend with Teflon®.

7. The electrodeposited polymer base coat of claim 6 which is CorMax® III.

8. The substrate surface coating of claim 1 wherein the UV curable polymer is selected from the group consisting of epoxyacrylates, polyester oligomers, polyacrylamides, polyacrylates, polymethacrylates, epoxysilicones and epoxyesters.

9. The substrate surface coating of claim 1 wherein the metal coating is chromium nitride, chromium carbide, chromium oxynitride, chromium oxycarbide, chromium carbide nitride or chromium nickel.

10. A chrome or chrome-alloy coated substrate comprising an electrodeposited polymer base coat, an ultraviolet curable polymer coat over the base coat, an ion plasma deposited (IPD) deposited chrome or chrome-alloy coat and, optionally, a polymer top coat over the IPD deposited chrome or chrome-alloy.

11. The coated substrate of claim 10 wherein the electrodeposited polymer base coat is about 1 to about 10 microns thick.

12. The coated substrate of claim 10 wherein the ultraviolet cured polymer coat is about 5 to about 15 microns thick.

13. The coated substrate of claim 10 wherein the chrome or chrome-alloy is about 5 nm to about 500 nm thick.

14. The coated substrate of claim 10 wherein the polymer top coat is about 1 to about 20 microns thick.

15. The coated substrate of claim 10 wherein the IPD produces a nano-smooth substantially macro particle free film.

16. The coated substrate of claim 10 wherein the IPD produces a nano-rough macro particle dense film.

17. The coated substrate of claim 10 which is a vehicular part.

18. The vehicular part of claim 17 which is an automotive part selected from the group consisting of wheel, hubcap, bumper, door handle, mirror attachment, and decorative appurtenant.

19. A method for producing a highly adherent chrome finish on a plastic or metal substrate, comprising the steps:
optionally electrodepositing a polymer base coat on a clean substrate surface;
coating the plastic or metal substrate with an ultraviolet curable polymer; and
depositing a metallic chrome-containing layer on top of the UV curable polymer by ion plasma deposition (IPD) under controlled arc speed conditions or adjustable substrate distance from the target selected to produce a substantially macro free smooth metal particle coated surface
wherein the chrome finish is highly adherent and meets or exceeds ASTM D-3359 standards.

20. The method of claim 19 wherein the macro free particle coating is produced by controlling the IPD at about 300 Hz.

21. The method of claim 19 wherein the metallic chrome-containing layer is deposited from a target comprising chromium nitride, chromium carbide, chromium oxynitride, chromium oxycarbide, chromium carbide nitride or chromium nickel.

22. The method of claim 19 wherein the metal or plastic substrate is an automobile part.

23. The method of claim 19 wherein the electrodeposited polymer base coat is selected from the group consisting of CorMax® III, CorMax® Vi, CorMax® VI EP, CorMax® VI HAPS free, CorMax® for frames, CorMax® VI low bake, CorMax® VI Kai and CorMax® pre-blend with Teflon®.

24. The method of claim 19 wherein the UV curable polymer is selected from the group consisting of polyethylene glycol diacrylate polyvinylidene fluoride blend gels, urethane acrylate, polyacrylamide polyvinyl alcohol, unsaturated polyester resins, hyperbranched polyesters, star branched polyesters and epoxy functional diorganopolysiloxanes.

25. A method for producing a highly adherent metal coating on a plastic substrate surface, comprising:
coating the plastic substrate surface with an ultraviolet curable polymer;
curing the polymer under ultraviolet radiation for a period of time sufficient to fully cure the polymer; and
depositing a metallic chrome-containing layer on top of the UV cured polymer by ion plasma deposition (IPD) under controlled arc speed or adjustable substrate distance from the target selected to produce a substantially macro free particle coating
wherein the chrome finish is highly adherent and meets or exceeds ASTM D-3359 standards.
